(19) United States
(12) Patent Application Publication
(10) Pub. No.: US 2016/0204520 A1
(43) Pub. Date: Jul. 14, 2016

(54) MULTI-BAND ANTENNA WITH A TUNED PARASITIC ELEMENT

(71) Applicant: QUALCOMM Incorporated, San Diego, CA (US)

(72) Inventors: Yuandan Dong, San Diego, CA (US); Jatupum Jenwatanavet, San Diego, CA (US); Allen Minh-Triet Tran, San Diego, CA (US)

(21) Appl. No.: 14/592,746

(22) Filed: Jan. 8, 2015

(51) Int. Cl. H01Q 21/30; H01Q 21/00

(52) U.S. Cl. CPC H01Q 21/30; H01Q 21/0006

(57) ABSTRACT

A multi-band antenna having a tuned antenna element is disclosed. The multi-band antenna may simultaneously transmit a first radio frequency (RF) and a second RF signal. The antenna may include a driven antenna element to radiate the first RF signal and a parasitic element to radiate the second RF signal. The parasitic element may be coupled to a ground plane through a tuning circuit. The tuning circuit may modify a resonant wavelength of the parasitic element according to the second RF signal.

### TECHNICAL FIELD

The exemplary embodiments relate generally to antennas, and specifically to a multi-band antenna with a tuned parasitic element.

### BACKGROUND OF RELATED ART

A wireless device (e.g., a cellular phone or a smartphone) in a wireless communication system may transmit and receive data for two-way communication. The wireless device may include a transmitter for data transmission and a receiver for data reception. For data transmission, the transmitter may modulate a radio frequency (RF) carrier signal with data to generate a modulated RF signal, amplify the modulated RF signal to generate a transmit RF signal having the proper output power level, and transmit the transmit RF signal via an antenna to a base station. For data reception, the receiver may obtain a received RF signal via the antenna and may amplify and process the received RF signal to recover data sent by the base station.

The wireless device may operate within multiple frequency bands. For example, the wireless device may transmit and/or receive an RF signal within a first frequency band and/or within a second frequency band. In many cases, an antenna design for the wireless device may depend on the frequency band used during operation. Different frequency bands (having different associated wavelengths) often dictate different antenna sizes. For example, a length of an antenna element may be selected to be a wavelength multiple (λ/4, λ/2 etc.) of the RF signal. Thus, an antenna designed for use within the first frequency band may have a different antenna element length compared to an antenna designed for use within the second frequency band. Using separate antennas for each frequency band may increase the size, cost, and complexity of the wireless device.

Thus, there is a need to reduce the number of antennas used within wireless devices that operate within multiple frequency bands.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1 shows a wireless device communicating with a wireless communication system, in accordance with some exemplary embodiments.

FIG. 2 shows an exemplary design of a receiver and a transmitter of FIG. 1.

FIG. 3 is a band diagram depicting three exemplary band groups that may be supported by the wireless device of FIG. 1.

FIG. 4 is a simplified diagram of an exemplary embodiment of an antenna.

FIG. 5 is a simplified diagram of another exemplary embodiment of an antenna.

FIGS. 6a-6e show exemplary embodiments of a tuning circuit shown in FIGS. 4 and 5.

FIG. 7 is a block diagram of an exemplary tuning circuit controller, in accordance with some embodiments.

FIG. 8 is a perspective view of an exemplary embodiment an antenna.

FIG. 9 depicts a device that is another exemplary embodiment of the wireless device of FIG. 1.

FIG. 10 shows an illustrative flow chart depicting an exemplary operation for the wireless device of FIG. 1, in accordance with some embodiments.

### DETAILED DESCRIPTION

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature and/or details are set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

In addition, the detailed description set forth below in connection with the appended drawings is intended as a description of exemplary embodiments of the present disclosure and is not intended to represent the only embodiments in which the present disclosure may be practiced. The term “exemplary” used throughout this description means “serving as an example, instance, or illustration,” and should not necessarily be construed as preferred or advantageous over other embodiments.

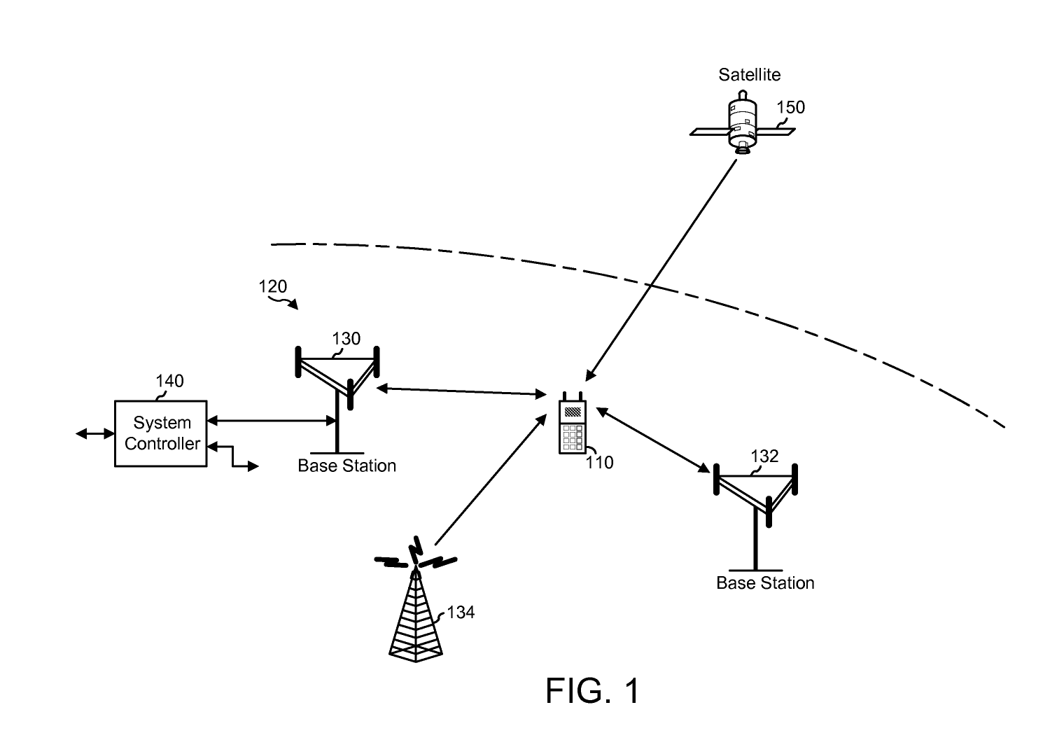

FIG. 1 shows a wireless device 110 communicating with a wireless communication system 120, in accordance with some exemplary embodiments. Wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless communication system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1X, EVDO, TD-SCDMA, GSM, 802.11, etc.

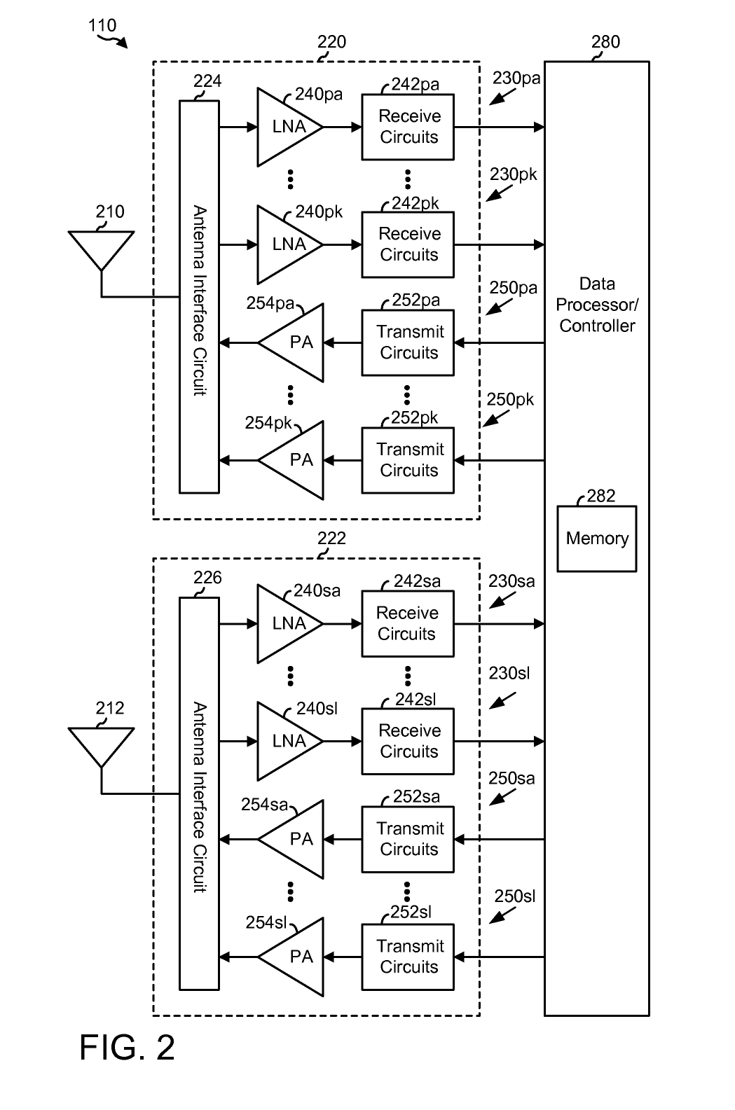

FIG. 2 shows a block diagram of an exemplary design of wireless device 110 in FIG. 1. In this exemplary design, wireless device 110 includes a primary transceiver 220 coupled to a primary antenna 210, a secondary transceiver 222 coupled to a secondary antenna 212, and a data processor/controller 280. Primary transceiver 220 includes a number (K) of receivers 230pa to 230pk and a number (K) of transmitters 250pa to 250pk to support multiple frequency bands, multiple radio technologies, carrier aggregation, etc. Secondary transceiver 222 includes a number (L) of receivers 230sa to 230sl and a number (L) of transmitters 250sa to 250sl to support multiple frequency bands, multiple radio technologies, carrier aggregation, receive diversity, multiple-input multiple-output (MIMO) transmission from multiple transmit antennas to multiple receive antennas, etc.

In the exemplary design shown in FIG. 2, each receiver 230 includes a low noise amplifier (LNA) 240 and receive circuits 242. For data reception, primary antenna 210 receives signals from base stations and/or other transmitter stations and provides a received radio frequency (RF) signal, which is routed through an antenna interface circuit 224 and presented as an input RF signal to a selected receiver. Antenna interface circuit 224 may include switches, duplexers, transmit filters, receive filters, matching circuits, etc. The description below assumes that receiver 230pa is the selected receiver. Within receiver 230pa, an LNA 240pa amplifies the input RF signal and provides an output RF signal. Receive circuits 242pa downconvert the output RF signal from RF to baseband, amplify and filter the downconverted signal, and provide an analog input signal to data processor/controller 280. Receive circuits 242pa may include mixers, filters, amplifiers, matching circuits, an oscillator, a local oscillator (LO) generator, a phase locked loop (PLL), etc. Each remaining receiver 230 in transceivers 220 and 222 may operate in similar manner as receiver 230pa.

In the exemplary design shown in FIG. 2, each transmitter 250 includes transmit circuits 252 and a power amplifier (PA) 254. For data transmission, data processor/controller 280 processes (e.g., encodes and modulates) data to be transmitted and provides an analog output signal to a selected transmitter. The description below assumes that transmitter 250pa is the selected transmitter. Within transmitter 250pa, transmit circuits 252pa amplify, filter, and upconvert the analog output signal from baseband to RF and provide a modulated RF signal. Transmit circuits 252pa may include amplifiers, filters, mixers, matching circuits, an oscillator, an LO generator, a PLL, etc. A PA 254pa receives and amplifies the modulated RF signal and provides a transmit RF signal having the proper output power level. The transmit RF signal is routed through antenna interface circuit 224 and transmitted via primary antenna 210. Each remaining transmitter 250 in transceivers 220 and 222 may operate in similar manner as transmitter 250pa.

Each receiver 230 and transmitter 250 may also include other circuits not shown in FIG. 2, such as filters, matching circuits, etc. All or a portion of transceivers 220 and 222 may be implemented on one or more analog integrated circuits (ICs), RF ICs (RFICs), mixed-signal ICs, etc. For example, LNAs 240 and receive circuits 242 within transceivers 220 and 222 may be implemented on multiple IC chips, as described below. The circuits in transceivers 220 and 222 may also be implemented in other manners.

Data processor/controller 280 may perform various functions for wireless device 110. For example, data processor/controller 280 may perform processing for data being received via receivers 230 and data being transmitted via transmitters 250. Data processor/controller 280 may control the operation of the various circuits within transceivers 220 and 222. A memory 282 may store program codes and data for data processor/controller 280. Data processor/controller 280 may be implemented on one or more application specific integrated circuits (ASICs) and/or other ICs.

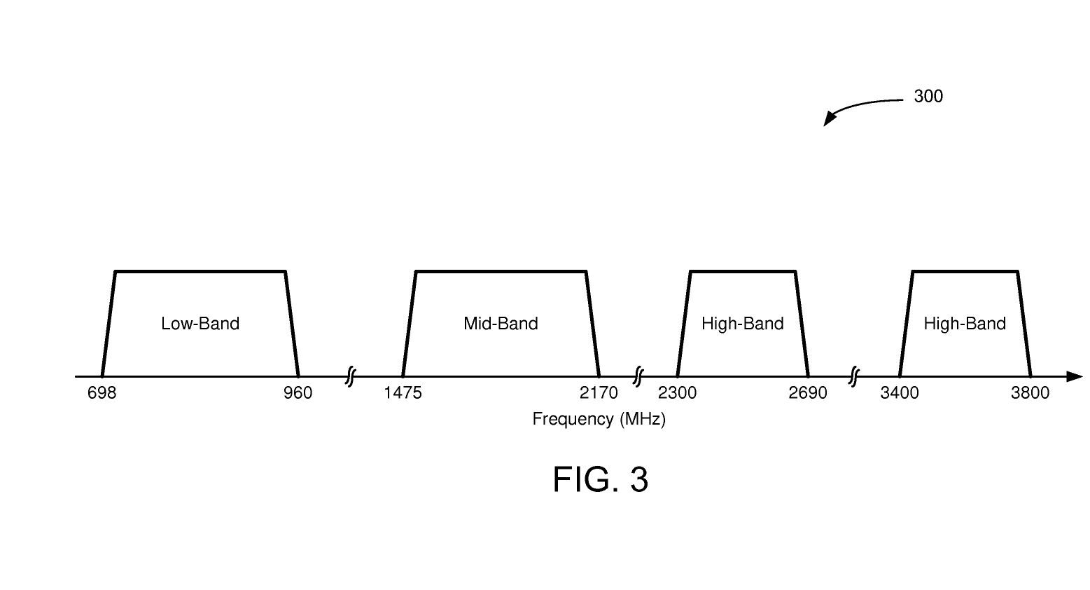

FIG. 3 is a band diagram 300 depicting three exemplary band groups that may be supported by wireless device 110. In some embodiments, wireless device 110 may operate in a low-band (LB) including RF signals having frequencies lower than 1000 megahertz (MHz), a mid-band (MB) including RF signals having frequencies from 1000 MHz to 2300 MHz, and/or a high-band (HB) including RF signals having frequencies higher than 2300 MHz. For example, low-band RF signals may cover from 698 MHz to 960 MHz, mid-band RF signals may cover from 1475 MHz to 2170 MHz, and high-band RF signals may cover from 2300 MHz to 2690 MHz and from 3400 MHz to 3800 MHz, as shown in FIG. 3. Low-band, mid-band, and high-band refer to three groups of bands (or band groups), with each band group including a number of frequency bands (or simply, “bands”). Each band may cover up to 200 MHz. LTE Release 11 supports 35 bands, which are referred to as LTE/UMTS bands and are listed in 3GPP TS 36.101.

In general, any number of band groups may be defined. Each band group may cover any range of frequencies, which may or may not match any of the frequency ranges shown in FIG. 3. Each band group may also include any number of bands.

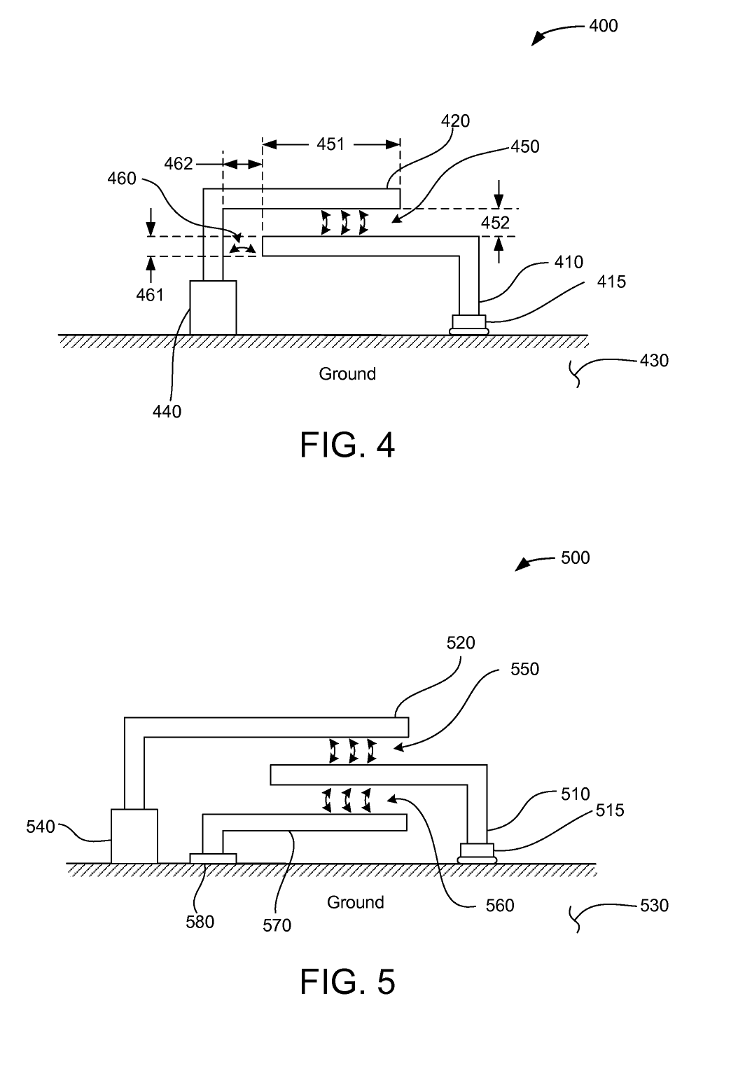

FIG. 4 is a simplified diagram of an exemplary embodiment of an antenna 400. Antenna 400 may be primary antenna 210, secondary antenna 212, or any other antenna coupled to wireless device 110 (see FIG. 2). Antenna 400 may include a driven antenna element 410, a parasitic antenna element 420, a feed point 415, and a tuning circuit 440. Antenna 400 may be disposed on, or be adjacent to, a substrate 430. Substrate 430 may also function as a ground plane. Substrate 430 may be any technically feasible substrate such as a copper-clad printed circuit board having a fiberglass (e.g., FR-4), Rogers, Nelco®, or any other technically feasible dielectric core. In some embodiments, substrate 430 may be a simple layer of metal such as copper, aluminum or any other technically feasible electrical conductor.

Antenna 400 may be coupled to a transmitter and/or receiver through feed point 415. For example, one or more transmitters 250 (250pa-250pk or 250sa-250sl, of FIG. 2) may be coupled to feed point 415 to provide an RF signal to be transmitted. Similarly, antenna 400 may be coupled to one or more receivers 230 (230pa-230pk or 230sa-230sl, of FIG. 2) to provide a received RF signal.

In some embodiments, the RF signal to be transmitted may include two signals such as a first RF signal and a second RF signal. The first RF signal may be within a first frequency band and the second RF signal may be within a second frequency band. Thus, in some embodiments, antenna 400 may be a multi-band antenna that simultaneously operates within the first frequency band and the second frequency band. Driven antenna element 410 may be a monopole antenna element with a length λ₁ (e.g., resonant wavelength) selected to be a wavelength multiple associated with the first RF signal. For example, if λ is a wavelength of the first RF signal, then λ₁ may be any technically feasible multiple of λ such as, but not limited to, λ/4, λ/2, etc. Driven antenna element 410 with length λ₁ may radiate the first RF signal within the first frequency band. Driven antenna element 410 may also radiate the second RF signal.

Parasitic antenna element 420 may be capacitively and/or inductively coupled to driven antenna element 410. Parasitic antenna element 420 may capture at least a portion of the second RF signal radiated by driven antenna element 410. In some embodiments, parasitic antenna element 420 may have a length λ₂ selected to be a wavelength multiple associated with the second RF signal. Thus, parasitic antenna element 420 with length λ₂ may radiate the second RF signal within the second frequency band. In some embodiments, length λ₂ in conjunction with length λ₁, may be selected to be a wavelength multiple associated with the second frequency band. Thus, parasitic antenna element 420 (and, in some embodiments, driven antenna element 410) may radiate the second RF signal within the second frequency band.

Although shown in a simplified form in FIG. 4, driven antenna element 410 and/or parasitic antenna element 420 may be formed to have any technically feasible shape. For example, driven antenna element 410 and/or parasitic antenna element 420 may have a serpentine form. In some embodiments, an antenna element with a serpentine form may provide a relatively compact antenna element while maintaining a desired length. For example, parasitic antenna element 420 may serpentine back and forth to allow a compact implementation of an antenna element with length A₂. In other embodiments, driven antenna element 410 may have a serpentine form.

Parasitic antenna element 420 may be coupled to tuning circuit 440 which, in turn, may be coupled to ground (e.g., substrate 430 functioning as a ground plane). In some embodiments, tuning circuit 440 may be an antenna tuning circuit and/or integrated circuit. Tuning circuit 440 may couple parasitic antenna element 420 to ground through one or more reactive and/or resistive elements to modify an effective length (e.g., resonant wavelength) of parasitic antenna element 420. In this manner, while a physical length of parasitic antenna element 420 may remain constant, the effective length of parasitic antenna element 420 may be modified via tuning circuit 440. Thus, the effective length of parasitic antenna element 420 may be adjusted for different wavelengths. Since length of driven antenna element 410 is relatively fixed, the resonant wavelength of driven antenna element 410 is also relatively fixed. In some embodiments, no additional impedance matching circuits or components may be required to be coupled to antenna 400 since the length of driven antenna element 410 is relatively fixed. In contrast, since the effective length of parasitic antenna element 420 may be modified by tuning circuit 440, the resonant wavelength of parasitic antenna element 420 may be modified to accommodate a range of wavelengths.

Parasitic antenna element 420 may capture and re-radiate RF signals from driven antenna element 410. In some embodiments, parasitic antenna element 420 may capture RF signals radiating across gaps that may run parallel or perpendicular to portions of driven antenna element 410 and parasitic antenna element 420. For example, a first coupling region 450 may exist where driven antenna element 410 is parallel to parasitic antenna element 420. In first coupling region 450, driven antenna element 410 may be capacitively and/or inductively coupled to parasitic antenna element 420 across an air gap 452. Thus, capture of RF signals by parasitic antenna element 420 may be controlled, at least in part, by a length 451 of first coupling region 450 and/or a distance of air gap 452. In another example, a second coupling region 460 may exist where driven antenna element 410 is perpendicular to parasitic antenna element 420. In second coupling region 460, driven antenna element 410 may be capacitively and/or inductively coupled to parasitic antenna element 420 across an air gap 462. Thus, capture of RF signals by parasitic antenna element 420 may be controlled, at least in part, by a length 461 of second coupling region 460 and/or a distance of air gap 462. Although only first coupling region 450 and second coupling region 460 are shown for simplicity, other embodiments of antenna 400 may include any number of coupling regions. In some embodiments, distance of air gap 452 and/or air gap 462 may be inversely related to the second frequency band associated with the second RF signal. For example, as the frequency of the second frequency band increases, then the distance of air gap 452 and/or air gap 462 may decrease.

In some embodiments, when parasitic antenna element 420 is coupled to driven antenna element 410, an antenna aperture associated with antenna 400 may be increased. As is well-known, the antenna aperture is a measure of an antenna's effectiveness at receiving radio waves. Coupling parasitic antenna element 420 to driven antenna element 410 may increase the antenna aperture of antenna 400 by, for example, receiving radio signals with an antenna element having an effective length of λ₁+λ₂,

In some embodiments, frequencies of the first RF signal may be relatively higher than frequencies of the second RF signal. For example, driven antenna element 410 may transmit and/or receive the first RF signal having frequencies within the high-band. Parasitic antenna element 420 may transmit and/or receive the second RF signal having frequencies within the low-band. In some embodiments, antenna 400 may simultaneously transmit the first RF signal and the second RF signal. For example, feed point 415 may simultaneously receive the first RF signal and the second RF signal. Driven antenna element 410 may radiate the first RF signal while parasitic antenna element 420 may radiate the second RF signal. In some other embodiments, a physical length of driven antenna element 410 may be relatively shorter than the physical length of parasitic antenna element 420. In at least some embodiments, the physical length of an antenna element may be related to the frequency of the RF signal associated with the antenna element. For example, when frequencies of the first RF signal are relatively higher than frequencies of the second RF signal, then the physical length of the driven antenna element 410 may be shorter than the physical length of the parasitic antenna element 420.

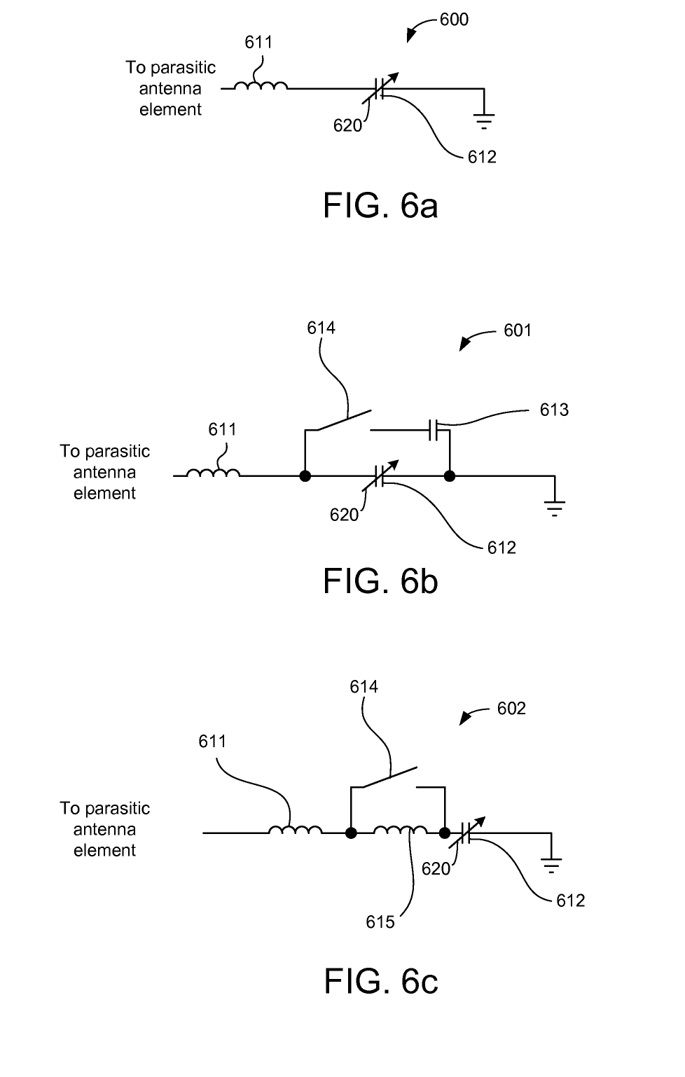

FIG. 5 is a simplified diagram of another exemplary embodiment of an antenna 500. Antenna 500 may include a driven antenna element 510, a feed point 515, a first parasitic antenna element 520, a first tuning circuit 540, a second parasitic antenna element 570, a second tuning circuit 580, and a substrate 530. Although only two parasitic antenna elements 520 and 570 are shown for simplicity, other embodiments of antenna 500 may include any number of parasitic antenna elements. Antenna 500 may be disposed on, or be adjacent to, substrate 530 that may also function as a ground plane.

Similar to as described above in FIG. 4, driven antenna element 510 may be coupled to one or more transmitters 250 and/or receivers 230 via feed point 515 (see also FIG. 2). An RF signal including a first RF signal, a second RF signal, and a third RF signal may be provided to feed point 515. The first RF signal may be within a first frequency band, the second RF signal may be within a second frequency band, and the third RF signal may be within a third frequency band. In some embodiments, a length of driven antenna element 510 may be λ₃, which may be a wavelength multiple associated with the first RF signal. Thus, driven antenna element 510 may transmit and/or receive RF signals within the first frequency band. In some embodiments, driven antenna element 510 may be a monopole antenna element.

First parasitic antenna element 520 may be capacitively and/or inductively coupled to driven antenna element 510 through a first coupling region 550. First parasitic antenna element 520 may capture at least a portion of the second RF signal radiated by driven antenna element 510. In some embodiments, first parasitic antenna element 520 may have a length λ₄ that may be selected to be a wavelength multiple associated with the second RF signal. In other embodiments, length λ₄, in conjunction with length λ₃, may be selected to be a wavelength multiple associated with the second RF signal. First parasitic antenna element 520 may transmit and/or receive second RF signals within the second frequency band.

In a similar manner, second parasitic antenna element 570 may be capacitively and/or inductively coupled to driven antenna element 510 through a second coupling region 560. Second parasitic antenna element 570 may capture at least a portion of the third RF signal radiated by driven antenna element 510. In some embodiments, second parasitic antenna element 570 may have a length λ₅ that may be selected to be a wavelength multiple associated with the third RF signal. In other embodiments, length λ₅, in conjunction with length λ₃, may be selected to be a wavelength multiple associated with the third RF signal. Thus, antenna 500 may simultaneously operate within the first, second, and third frequency bands. Although only two coupling regions 550 and 560 are shown for simplicity, other embodiments of antenna 500 may include different numbers of coupling regions.

Although shown in a simplified form in FIG. 5, driven antenna element 510, first parasitic antenna element 520, and/or second parasitic antenna element 570 may be formed to have any technically feasible shape. For example, driven antenna element 510, first parasitic antenna element 520, and/or second parasitic antenna element 570 may have a serpentine form. For example, second parasitic antenna element 570 may serpentine back and forth to allow a compact implementation of an antenna element with length λ₅. In other embodiments, driven antenna element 510 and/or first parasitic element 520 may have a serpentine form.

First parasitic antenna element 520 may be coupled to ground (e.g., substrate 530 functioning as a ground plane) through first tuning circuit 540 and second parasitic antenna element 570 may be coupled to ground through second tuning circuit 580. First tuning circuit 540 may couple first parasitic antenna element 520 to ground through one or more reactive and/or resistive elements. Similarly, second tuning circuit 580 may couple second parasitic antenna element 570 to ground through one or more reactive and/or resistive elements. First tuning circuit 540 and second tuning circuit 580 may modify an effective length of first parasitic antenna element 520 and an effective length of second parasitic antenna element 570, respectively. In this manner, the effective length of first parasitic antenna element 520 may be adjusted for wavelengths associated with the second RF signal, and the effective length of second parasitic antenna element 570 may be adjusted for wavelengths associated with the third RF signal. Thus, antenna 500 may be tuned to accommodate a range of frequencies for the second frequency band and/or the third frequency band.

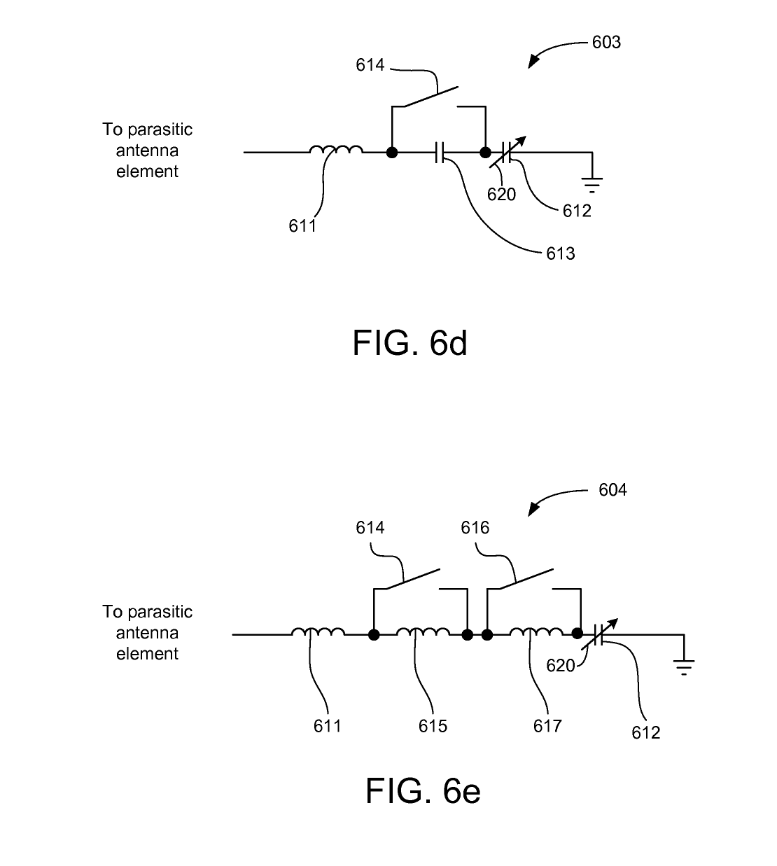

FIGS. 6a-6e show various exemplary embodiments of tuning circuits 440, 540, and/or 580 depicted in FIGS. 4 and 5. The embodiments described herein are not meant to be limiting, but rather illustrative in nature. In some embodiments, tuning circuits 440, 540, and/or 580 may couple discrete reactive and/or resistive components between a parasitic antenna element (e.g. parasitic antenna elements 420, 520, and/or 570) and ground. In some other embodiments, tuning circuits 440, 540, and/or 580 may include an integrated circuit to selectively couple one or more reactive and/or resistive components between parasitic antenna elements 420, 520, and/or 570 and ground.

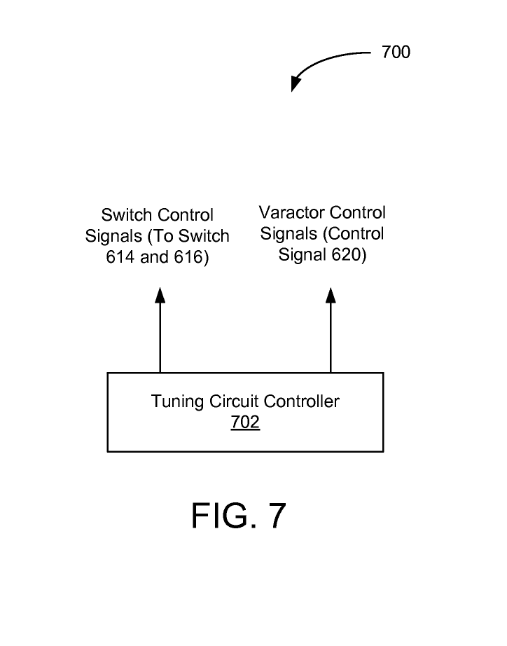

FIG. 6a shows a first exemplary embodiment of a tuning circuit 600 that may include a varactor (variable capacitor) 612 and a first inductor 611. First inductor 611 may couple a parasitic antenna element (not shown for simplicity) to varactor 612. In some embodiments, first inductor 611 may not be included within tuning circuit 600, but still may be used to couple tuning circuit 600 to the parasitic antenna element. Varactor 612 may couple first inductor 611 to ground. In some embodiments, varactor 612 may be tunable between 0-8 pF, although other tunable ranges may be achieved with varactor 612. A varying reactance (e.g., capacitance and/or inductance) between the parasitic antenna element and ground may vary the effective length of the parasitic antenna element. Thus, tuning circuit 600 may allow a wider bandwidth of RF signals to be radiated and/or captured by the parasitic antenna element. In some embodiments, varactor 612 may be controlled by a varactor control signal 620 provided by a tuning circuit controller described below in conjunction with FIG. 7. In other embodiments, varactor 612 may be a tunable capacitor such as a Micro Electro-Mechanical System (MEMS) digital variable capacitor. The capacitance of the MEMS digital variable capacitor may be controlled by a digital interface. In such embodiments, a varactor control signal 620 may be a digital voltage.

FIG. 6b shows a second exemplary embodiment of a tuning circuit 601 that may include varactor 612, first inductor 611, a capacitor 613, and a first switch 614. First inductor 611 may couple the parasitic antenna element to tuning circuit 601. Varactor 612 may couple first inductor 611 to ground. First switch 614 may selectively couple capacitor 613 in parallel with varactor 612. Selectively coupling capacitor 613 in parallel with varactor 612 may add additional capacitance to varactor 612, for example, to vary the effective length of the parasitic antenna element. In some embodiments, varactor control signal 620 and/or configuration of first switch 614 may be controlled by the tuning circuit controller described below in conjunction with FIG. 7.

FIG. 6c shows a third exemplary embodiment of a tuning circuit 602. Tuning circuit 602 may include first inductor 611, varactor 612, first switch 614, and a second inductor 615. First inductor 611 may couple the parasitic antenna element to second inductor 615 which, in turn, may be coupled to varactor 612. Varactor 612 may be coupled to ground. First switch 614, which is coupled in parallel with inductor 615, may selectively isolate second inductor 615 from the parasitic antenna element, for example, to vary the effective length of the parasitic antenna element. In some embodiments, varactor control signal 620 and/or configuration of first switch 614 may be controlled by the tuning circuit controller described below in conjunction with FIG. 7.

FIG. 6d shows a fourth exemplary embodiment of a tuning circuit 603. Tuning circuit 603 may include first inductor 611, first switch 614, capacitor 613, and varactor 612. First inductor 611 may couple the parasitic antenna element to capacitor 613 which, in turn, may be coupled to varactor 612. Varactor 612 may be coupled to ground. First switch 614, which is coupled in parallel with capacitor 613, may selectively isolate capacitor 613 from the parasitic antenna element, for example, to vary the effective length of the parasitic antenna element. In some embodiments, varactor control signal 620 and/or configuration of first switch 614 may be controlled by the tuning circuit controller described below in conjunction with FIG. 7.

FIG. 6e shows a fifth exemplary embodiment of a tuning circuit 604. Tuning circuit 604 may include first inductor 611, second inductor 615, a third inductor 617, first switch 614, a second switch 616, and varactor 612. First inductor 611 may couple the parasitic antenna element to second inductor 615. Second inductor 615 may be coupled to third inductor 617 which, in turn, may be coupled to varactor 612. Varactor 612 may be coupled to ground. First switch 614, which is coupled in parallel to second inductor 615, may selectively isolate second inductor 613 from tuning circuit 604. Similarly, second switch 616, which is coupled in parallel to third inductor 617, may selectively isolate third inductor 615 from tuning circuit 604. Isolating some reactive components from the parasitic antenna element may, for example, vary the effective length of the parasitic antenna element. In some embodiments, varactor control signal 620, configuration of first switch 614, and/or configuration of second switch 616 may be controlled by the tuning circuit controller described below in conjunction with FIG. 7.

Tuning circuits 600-604 may be shown in a simplified form. Persons skilled in the art will recognize that other circuits and components (e.g., biasing components, current sources, power supplies, and so forth) may be omitted for simplicity.

FIG. 7 is a block diagram 700 of an exemplary tuning circuit controller 702, in accordance with some embodiments. Tuning circuit controller 702 may control a tuning circuit (not shown for simplicity) to vary an effective length of a parasitic antenna element (not shown for simplicity). For at least some embodiments, tuning circuit may be tuning circuit 440 of FIG. 4, first tuning circuit 540 or FIG. 5, or second tuning circuit 580 of FIG. 5. Similarly, for at least some embodiments, parasitic antenna element may be parasitic antenna element 420 of FIG. 4, parasitic antenna element 520 of FIG. 5, or parasitic antenna element 570 of FIG. 5. In other embodiments, tuning circuit controller 702 may control any technically feasible tuning circuit coupled to any technically feasible parasitic antenna element. In at least one embodiment, the effective length of the parasitic antenna element may be tuned to be a wavelength of the RF signal to be radiated and/or captured by the parasitic antenna element. As described above, the effective length of the parasitic antenna element may be varied by varying the reactance of the tuning circuit coupling the parasitic antenna element to ground.

In one embodiment, the reactance of the tuning circuit may be varied by changing varactor control signal 620 of varactor 612, thereby changing a capacitance associated with the tuning circuit. In another embodiment, the reactance may be varied by controlling first switch 614 and/or second switch 616 to couple reactive components to, or isolate reactive components from the tuning circuit, thereby changing a reactance associated with the tuning circuit. In still other embodiments, tuning circuit controller 702 may provide control signals for any technically feasible number of varactors and may control any technically feasible number of switches. Varactor control signal 620, configuration of first switch 614, and/or configuration of second switch 616 may be based on the wavelength of the RF signal to be captured and/or radiated by the parasitic antenna element. For example, the parasitic antenna element may be characterized prior to use by wireless device 110. After the wavelength of the RF signal is determined, tuning circuit controller 702 may control the varactor control signal 620, configuration of first switch 614, and/or configuration of second switch 616 to vary the effective length of the parasitic antenna element.

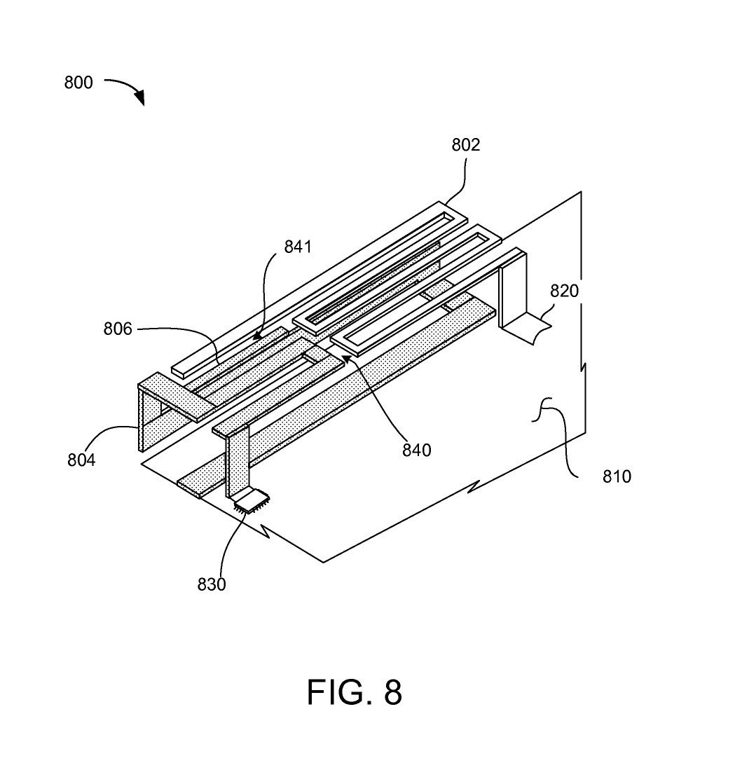

FIG. 8 is a perspective view of an exemplary embodiment of an antenna 800. Antenna 800 may include a driven antenna element 802 (shown clear within FIG. 8) and a parasitic antenna element 804 (shown shaded within FIG. 8). Driven antenna element 802 may be coupled to a feed point 820. For at least some embodiments, driven antenna element 802 may be driven antenna element 410 of FIG. 4 or driven antenna element 510 of FIG. 5. In a similar manner, parasitic antenna element 804 may be parasitic antenna element 420 of FIG. 4, parasitic antenna element 520 of FIG. 5, or parasitic antenna element 570 of FIG. 5. In some embodiments, driven antenna element 802 may be a monopole antenna element. Feed point 820 may receive RF signals to be transmitted by antenna 800. In some embodiments, feed point 820 may receive a first RF signal within a first frequency band and a second RF signal within a second frequency band. The first frequency band may be different from the second frequency band. For example, the first frequency band may be within a 2.4 GHz frequency band and the second frequency band may be within a 900 MHz frequency band. In other embodiments, the first RF signal and the second RF signal may be included within any technically feasible frequency band.

Parasitic antenna element 804 may be coupled to tuning circuit 830. Tuning circuit 830 may also be coupled to a ground plane 810. As described above in conjunction with FIGS. 6a-6e, tuning circuit 830 may include one or more reactive and/or resistive components to selectively couple parasitic antenna element 804 to ground (e.g., ground plane 810). Thus, tuning circuit 830 may be any one of tuning circuits 600-604 shown in FIGS. 6a-6e, respectively. In this manner, tuning circuit 830 may adjust the effective length of parasitic antenna element 804. In some embodiments, tuning circuit 830 may include an integrated circuit to selectively couple parasitic antenna element 804 to ground.

In some embodiments, parasitic antenna element 804 may be coupled to driven antenna element 802 when RF signals radiate through coupling regions 840 and 841. For example, an air gap between parasitic antenna element 804 and driven antenna element 802 in coupling regions 840 and 841 may allow an RF signal to radiate from driven antenna element 802 to parasitic antenna element 804. In some embodiments, a coupling stub 806 may be included within or attached to parasitic antenna element 804. For example, coupling stub 806 may be integrally formed and/or attached to parasitic antenna element 804. Coupling stub 806 may provide a coupling region, such as coupling region 841, to capture RF signals radiated from driven antenna element 802. In other embodiments, a coupling stub may be integrally formed and/or attached to driven antenna element 802 (not shown for simplicity).

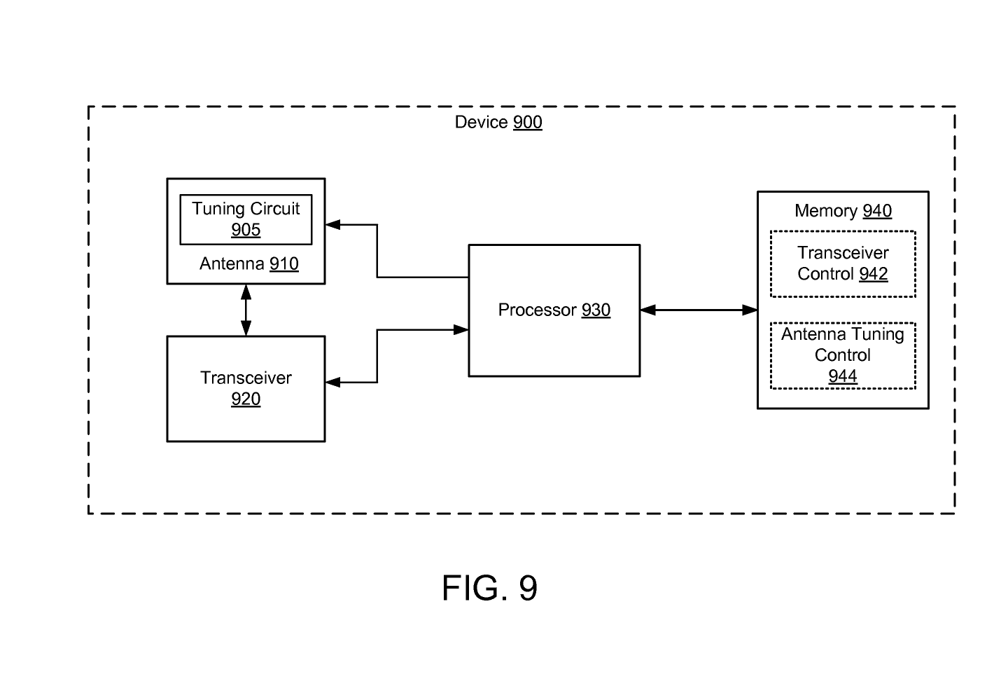

FIG. 9 depicts a device 900 that is another exemplary embodiment of wireless device 110 of FIG. 1. Device 900 includes an antenna 910, a transceiver 920, a processor 930, and a memory 940. In some embodiments, antenna 910 may be similar to one or more exemplary embodiments of antenna 400 or antenna 500 described above. Antenna 910 may include a tuning circuit 905 coupled to a parasitic antenna element (not shown for simplicity) of antenna 910 to modify the effective length of the parasitic antenna element. Transceiver 920 may be a multi-band transceiver capable of transmitting and receiving RF signals within two or more frequency bands.

Memory 940 may include a non-transitory computer-readable storage medium (e.g., one or more nonvolatile memory elements, such as EPROM, EEPROM, Flash memory, a hard drive, etc.) that may store the following software modules:
a transceiver control module 942 to select frequency bands within which to operate transceiver 920; and
an antenna tuning control module 944 to tune antenna 910 based on one or more selected frequency bands.
   Each software module includes program instructions that, when executed by processor 930, may cause the device 900 to perform the corresponding function(s). Thus, the non-transitory computer-readable storage medium of memory 940 may include instructions for performing all or a portion of the operations of FIG. 9.

Processor 930, which is coupled to antenna 910, transceiver 920, and memory 940, may be any one or more suitable processors capable of executing scripts or instructions of one or more software programs stored in device 900 (e.g., within memory 940).

Processor 930 may execute transceiver control module 942 to select one or more frequency bands within which to operate transceiver 920. For example, transceiver control module 942 may select a 2.4 GHz frequency band and/or a 900 MHz frequency band to operate transceiver 920. In other embodiments, transceiver 920 may operate within other frequency bands.

Processor 930 may execute antenna tuning control module 944 to tune antenna 910 based on at least one of the selected frequency bands used by transceiver 920. For example, when transceiver control module 942 operates transceiver 920 within the 2.4 GHz frequency band and the 900 MHz frequency band, then antenna tuning control module 944 may control tuning circuit 905 to tune a parasitic antenna element of antenna 910 to have an effective length associated with the 900 MHz frequency band. In some embodiments, the parasitic antenna element of antenna 910 may be characterized for use within a selected frequency band. Thus, predetermined reactance values (e.g., capacitance values provided by varactor 612 and/or inductance values from first inductor 611, second inductor 615, and/or third inductor 617) may be coupled to the parasitic antenna element of antenna 910 to provide predetermined effective lengths. In some embodiments, antenna tuning control module 944 may control varactor control signal 620, configuration of first switch 614, and/or configuration of second switch 616 to select predetermined reactance values to couple to the parasitic antenna element of antenna 910.

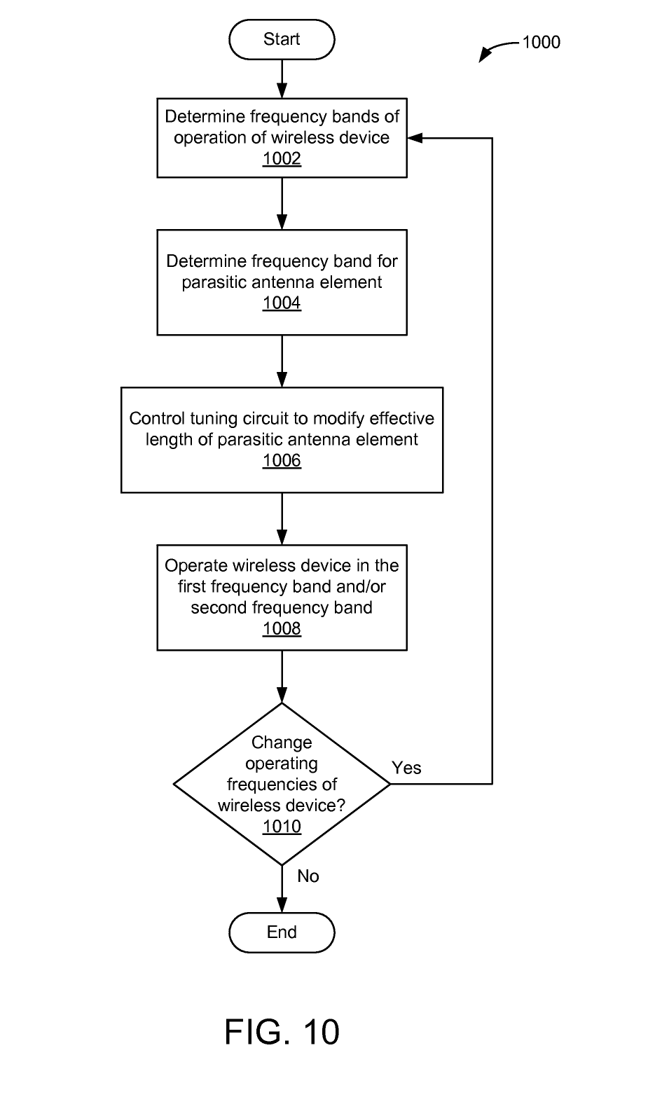

FIG. 10 shows an illustrative flow chart depicting an exemplary operation 1000 for wireless device 110, in accordance with some embodiments. Referring also to FIGS. 2, 4, and 5, frequency bands of operation of wireless device 110 are determined (1002). In some embodiments, wireless device 110 may operate within a first frequency band and a second frequency band. For example, transmit circuits 252pa may operate within the first frequency band and transmit circuits 252pk may operate within the second frequency band.

Next, a frequency band for the parasitic antenna element is determined (1004). Wireless device 110 may include antenna 400 as shown in FIG. 4 (or antenna 500 shown in FIG. 5). Driven antenna element 410 and parasitic antenna element 420 may be designed for selected frequency bands. Thus, one of the first frequency band or the second frequency band may be selected for use with parasitic antenna element 420. For example, if the first frequency band includes RF signals (e.g., wavelengths) similar to those that parasitic antenna element 420 may support, then the first frequency band may be selected for use with parasitic antenna element 420.

Next, a tuning circuit is controlled to modify the effective length of parasitic antenna element 420 (1006). For example, tuning circuit 440 (coupled to parasitic antenna element 420) may be used to modify the effective length of parasitic antenna element 420 based on the frequency band selected for use with the parasitic antenna element 420. In some embodiments, tuning circuit 440 may couple one or more reactive and/or resistive components between parasitic antenna element 420 and ground as described above in FIGS. 6a-6e.

Next, wireless device 110 operates within the first and/or second frequency bands (1008). For example, wireless device 110 may transmit and/or receive RF signals within the first and/or the second frequency band through antenna 400. In some embodiments, wireless device 110 may transmit and/or receive RF signals within the first frequency band and the second frequency band simultaneously. Next, a change of operating frequencies for wireless device 110 is determined (1010). If operating frequencies are to be changed, then operations proceed to 1002. If operating frequencies are not to be changed, then operations end.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A multi-band antenna, comprising:
a first antenna element configured to radiate a first radio frequency (RF) signal; and
a stub configured to capacitively couple the first antenna element to a second antenna element configured to radiate a second RF signal.

2. The antenna of claim 1, wherein the stub is integrally formed with the second antenna element.

3. The antenna of claim 1, wherein the stub is connected to the second antenna element.

4. The antenna of claim 1, further comprising:
a tuning circuit, coupled to the second antenna element, configured to modify a resonant wavelength of the second antenna element, wherein the tuning circuit comprises at least one of a variable capacitor or an inductor or a switch or a combination thereof.

5. The antenna of claim 1, further comprising:
a tuning circuit, coupled to the second antenna element, configured to couple the second antenna element to a ground plane disposed adjacent to the first antenna element and the second antenna element.

6. The antenna of claim 1, further comprising:
a feed point configured to simultaneously receive the first RF signal and the second RF signal.

7. The antenna of claim 1, wherein the first antenna element is a driven antenna element, and the second antenna element is a parasitic antenna element configured to capture the second RF signal from the first antenna element.

8. The antenna of claim 1, wherein the first antenna element is configured to radiate the first RF signal while the second antenna element is configured to simultaneously radiate the second RF signal.

9. The antenna of claim 1, wherein the second antenna element is configured to increase an antenna aperture associated with the multi-band antenna.

10. The antenna of claim 1, wherein the first RF signal has a frequency that is higher than a frequency of the second RF signal.

11. The antenna of claim 1, wherein the first antenna element is a monopole antenna element.

12. The antenna of claim 1, further comprising a third antenna element capacitively coupled to the first antenna element and configured to radiate a third RF signal, different from the first RF signal and the second RF signal.

13. A multi-band antenna, comprising:
means for radiating a first radio frequency (RF) signal; and
means for capacitively coupling the means for radiating the first RF signal to a means for radiating a second RF signal.

14. The antenna of claim 13, wherein the means for capacitively coupling is integrally formed with the means for radiating the second RF signal.

15. The antenna of claim 13, wherein the means for capacitively coupling is connected to the means for radiating the second RF signal.

16. The antenna of claim 13, further comprising:
means for simultaneously receiving the first RF signal and the second RF signal.

17. The antenna of claim 13, wherein the means for radiating the first RF signal comprises a driven antenna element, and the means for radiating the second RF signal comprises a parasitic antenna element configured to capture the second RF signal from the means for radiating the first RF signal.

18. The antenna of claim 13, wherein the first RF signal has a frequency that is higher than a frequency of the second RF signal.

19. A method, comprising:
radiating, at a first antenna element, a first radio frequency (RF) signal; and
capacitively coupling, via a stub, the first antenna element to a second antenna element radiating a second RF signal.

20. The method of claim 19, wherein the stub is integrally formed with the second antenna element.
